(19) United States
(12) Patent Application Publication
(10) Pub. No.: US 2014/0185614 A1
(43) Pub. Date: Jul. 3, 2014

(54) MULTIPLE DOMAIN ADDRESSING IN MESSAGE ROUTING

(71) Applicant: GENERAL INSTRUMENT CORPORATION, Horsham, PA (US)

(72) Inventors: James M. Hunter, San Jose, CA (US); Tim J. Spets, Algonquin, IL (US); Cedar W. Milazzo, San Jose, CA (US)

(73) Assignee: GENERAL INSTRUMENT CORPORATION, Horsham, PA (US)

(21) Appl. No.: 13/730,445

(22) Filed: Dec. 28, 2012

(51) Int. Cl. H04L 12/56

(52) U.S. Cl. CPC H04L 45/74
USPC 370/392

(57) ABSTRACT

In one embodiment, a method determines a first address of a sender and a second address of a receiver. The first address includes a first hierarchy of a plurality of domains and the second address includes a second hierarchy of a plurality of domains. The method then calculates a crossover point and an index based on the crossover point and the first hierarchy of the first address. The method sends a message from the sender to the receiver where the message includes the index. Before the index reaches a predefined value, each node that receives the message adjusts the index and sends the message to a parent node based on the first address. Also, when the index reaches a predefined value, each node sends the message to a child node based on the second address until a domain in which the receiver is located is reached.

### BACKGROUND

Various methods for sending information through networks exist. For example, Internet protocol version 4 (IPv4) and IPv6 route packets through an Internet protocol layer. These protocols use subnet masks to determine a parent node in which to route packets. The number of nodes that can be located in a hierarchy is limited using IPv4 and IPv6.

Another protocol is multi-protocol layer switching (MPLS), which directs packets from one network node to the next based on a short path of labels rather than long network addresses. When MPLS is used, a packet is tagged with a stack of labels that can be pushed or popped at each network node to allow protocol independent routing of packets across a network. The path in which to route the packets is embedded within the labels and labels are pushed or popped at each node. This, however, changes the routing address as each node sends the packet with a changed label. This may make it impossible to determine where the packet originated from because the labels at each network node are popped off or pushed.

Another mechanism is domain name system (DNS), which is a hierarchical distributed naming system. However, routing in DNS requires a centralized mechanism for mapping an address to an endpoint and relies on IP addressing underneath for routing.

### SUMMARY

In one embodiment, a method determines a first address of a sender and a second address of a receiver. The first address includes a first hierarchy of a plurality of domains and the second address includes a second hierarchy of a plurality of domains. The method then calculates a crossover point based on the first hierarchy and the second hierarchy where the crossover point is one of the domains in the first hierarchy and the second hierarchy that match. Then, an index is calculated based on the crossover point and the first hierarchy of the first address. The method sends a message from the sender to the receiver where the message includes the index. Before the index reaches a predefined value, each node that receives the message adjusts the index and sends the message to a parent node based on the first address. Also, when the index reaches a predefined value, each node sends the message to a child node based on the second address until a domain in which the receiver is located is reached.

In one embodiment, a method is provided including: receiving, at a first node, a message from a second node, the message including a first address of a sender and a second address of a receiver, the first address including a first hierarchy of a plurality of domains and the second address including a second hierarchy of a plurality of domains; determining an index for the message; determining if the index equals a predefined value; if the index does not equal the predefined value, sending the message to a parent node of the first node based on the first address; and if the index equals the predefined value, performing: verifying the first node is not in a domain of the receiver; if the first node is not in the domain of the receiver, sending the message to a child node of the first node based on the second address, wherein the index is adjusted if the message is sent to the parent node of the first node based on the first address and not adjusted if the message is sent to the child node of the first node based on the second address.

In one embodiment, a non-transitory computer-readable storage medium is provided containing instructions that, when executed, control a computer system to be configured for: determining a first address of a sender and a second address of a receiver, the first address including a first hierarchy of a plurality of domains and the second address including a second hierarchy of a plurality of domains; calculating a crossover point based on the first hierarchy and the second hierarchy, the crossover point being one of the domains in the first hierarchy and the second hierarchy that match; calculating an index based on the crossover point and the first hierarchy of the first address; and sending a message from the sender to the receiver, wherein the message includes the index, wherein: before the index reaches a predefined value, each node that receives the message adjusts the index and sends the message to a parent node based on the first address, and when the index reaches a predefined value, each node sends the message to a child node based on the second address until a domain in which the receiver is located is reached.

The following detailed description and accompanying drawings provide a more detailed understanding of the nature and advantages of particular embodiments.

### BRIEF DESCRIPTION OF THE DRAWINGS

FIG. 1 depicts a domain hierarchy for routing messages according to one embodiment.

FIG. 2 depicts simplified flowchart of a method for calculating the U index according to one embodiment.

FIG. 3 depicts an example of a message according to one embodiment.

FIG. 4 depicts a simplified flowchart of a method for routing messages using the U index according to one embodiment.

FIG. 5 depicts a more detailed example of a node according to one embodiment.

### DETAILED DESCRIPTION

Described herein are techniques for a system for routing messages. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

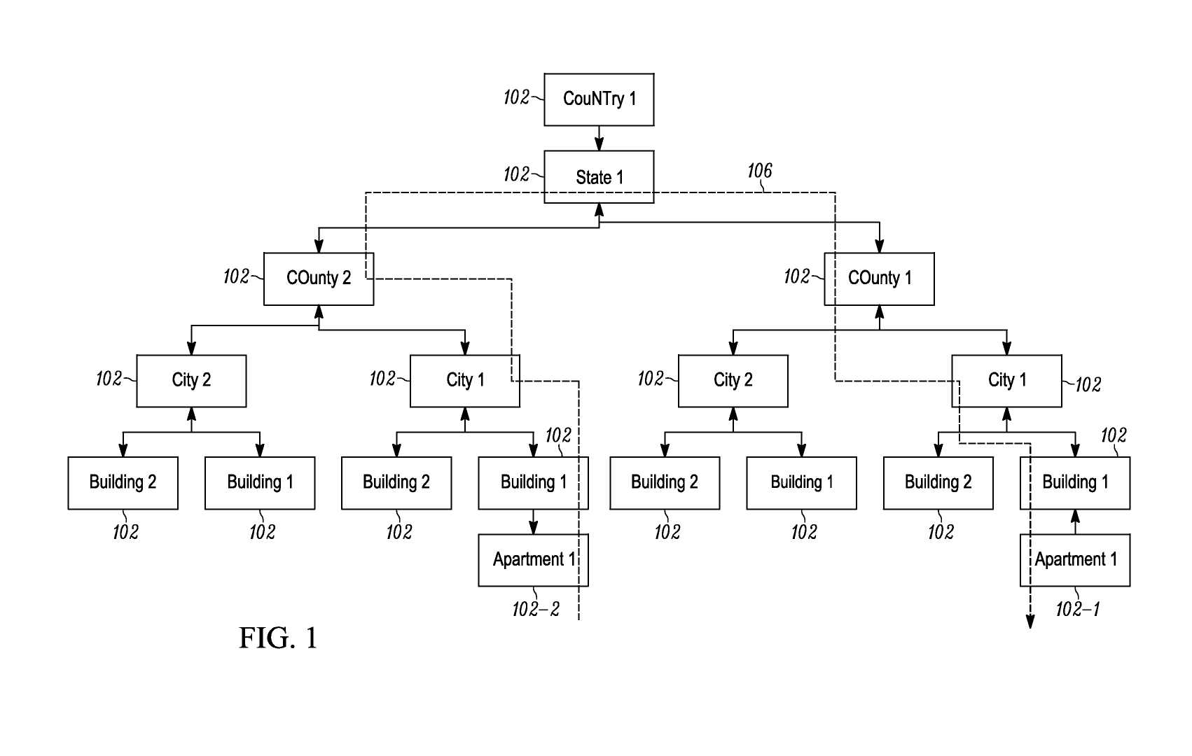

FIG. 1 depicts a domain hierarchy for routing messages according to one embodiment. Each domain is labeled with a geographic description. The domains are broken into levels, such as Country (cnt), State (s), County (co), City (c), Building (b), and Apartment (a). The abbreviations are designated by capitalizing the letters within the name, such as “CouNTry” for “cnt”. Within each level of a domain, a node 102 may be a server or other network device that is configured to route messages. Also, a domain may be a computer chip that is configured to process and route messages where multiple chips may be located in a single computing device.

Particular embodiments provide a hierarchical addressing scheme that allows each domain to route messages using an index. For example, the addressing scheme allows messages to be routed upstream and downstream through domains where nodes 102 reference the index in a message to determine whether to route the message upstream or downstream. As will be described in more detail below, when an index is a greater than pre-determined value, such as 0, the message is routed up the hierarchy, and when the message is equal to the pre-determined value, such as 0, the message is routed down in the hierarchy. Although this method of determining how to determine whether to route the message up or down the hierarchy is discussed, other methods may be used, such as a binary counter may be used.

In the domain hierarchy, the hierarchy from the highest to the lowest may be:

Country: cnt

State: s

County: co

City: c

Building: b

Apartment: a

Thus, the root domain is Country, a child domain to the Country domain is State, a child domain to the State domain is County, a child domain to the County domain is City, a child domain to the City domain is Building, and a child domain to the Building domain is Apartment.

Each message that is sent through the domains includes a “from” address and a “to” address. The “from” address is from a sender of the message and the “to” address is an address for a receiver of the message. An example of a “from” and “to” address may be:

### EXAMPLE A

< to=“cnt1.s1.co1.c1.b1.a1”
from=“cnt1.s1.co2.c1.b1.a1”>

In the above “to” address, the hierarchy is: Country 1: State 1: County 1: City 1: Building 1: Apartment 1. This identifies a node 102-1 as the “to” address. Also, for the “from” address, the hierarchy is: Country 1: State 1: County 2: City 1: Building 1: Apartment 1. This identifies node 102-2 as the sending domain.

In the domain hierarchy, all nodes 102 within the domain have a unique identifier. For example, when assigning a node name within a domain, the node name is unique within its hierarchy. In one example, a hierarchy of cn1.s1.co1.c1.h1.b1 is not a valid node name, but cn1.s1.co1.c1.h1.b1. and cn1.s1.co2.c1.h.1b1 are both valid node names. The reason why the first node name is not valid is because c1 is used for multiple domains in the hierarchy. Also, each domain in the hierarchy may be aware of the hierarchy above it and any immediate children below. Also, in one embodiment, in the hierarchy, a node 102 has only one direct parent node. For example, the node Apartment 1 has one parent node of Building 1, the node Building 1 has only one parent node of City 1, and so on. This means that the node Apartment 1 sends messages to the node Building 1, and the node Building 1 sends messages to the node City 1. In one embodiment, the address scheme is different from IP-based routing, which uses name resolution, because the address scheme of the present disclosure does not look up directories or services. Rather, it is a message routing addressing scheme, not an IP routing concept. Conventionally, when packets are routed, they are routed device to device using routing tables provided by routing information. To assist itself in making its routing decisions, a router builds routing tables to store information about routes to networks the router has previously discovered. In contrast, when messages are routed using particular embodiments, the nodes route the packets based on the addressing of the message itself In one embodiment, routing tables are not used, and not required. The node does not require any prior knowledge in routing the message, since the network crossover point is calculated ahead of time by the message originator. The message is the only source of the routing up the hierarchy by decrementing the index and routing message to the node's parent when a node encounters an index in the message>0.

As discussed above, particular embodiments use an index to route messages. In one embodiment, a sending domain calculates the index. For example, as will be described in more detail below, the sending domain determines the index, inserts the index in the message, and sends the message. Each subsequent domain (e.g., each node 102 that receives the message) in the route analyzes the index to determine the next domain, verifies the direction of the message, and routes the message either up or down the hierarchy.

In one embodiment, when the sending domain forms the message, the message includes:
1) to” address
2) “from” address
3) U(p) index.

The “to” address and the “from” address as described above are based on the domain hierarchy. The U index may be a counter that is decremented when received by a node in the domain hierarchy. If the U index is non-zero, nodes 102 continue to forward the message up the domain hierarchy. When the U index reaches 0, nodes 102 forward the message down the hierarchy until the destination is reached. Although zero is discussed as being the point at which to change routing from being forwarded up the hierarchy to being forwarded down the hierarchy, another value may be used. Also, counters may be implements using characters, binary numbers, etc.

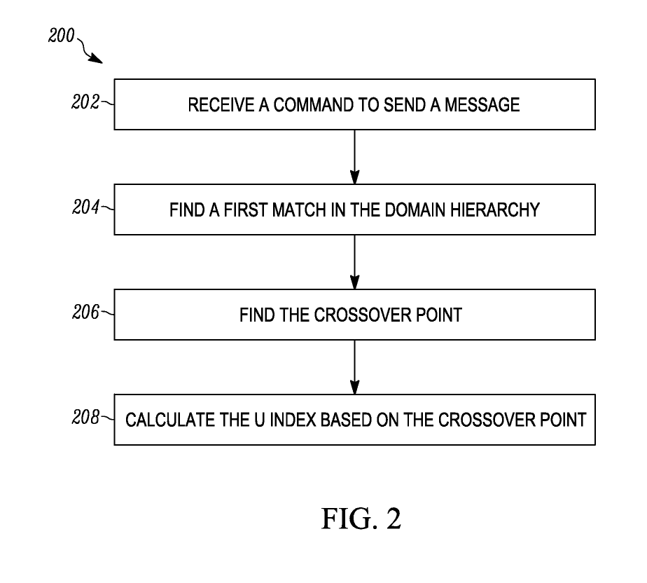

Once the “to” and “from” addresses are determined, a node 102 determines the index. FIG. 2 depicts simplified flowchart 200 of a method for calculating the U index according to one embodiment. At 202, a node in the sending domain receives a command to send a message. For example, a user may be using a computing device and sends a message, such as an instant message, to a receiver. The message is received by a node 102, which may be the computing device or a gateway, in the first domain, Apartment 1.

At 204, the node in the first domain finds a first match in the domain hierarchy. The message includes the “from” address and the “to” address, where the “from” address and the “to” address take a form in which delimited arrays, such as “.” denote different domains in the hierarchy. The “from” address and the “to” address may be in a from_array (“cnt1.s1.co2.c1.b1.a1”) and a to_array (“cnt1.s1.co1.c1.b1.a1”), respectively, where the highest hierarchy point is in the 0 array position (e.g., “cnt1”).

When sending a message from the “from” address to the “to” address, a crossover point is included in the “to” address and the “from” address. A crossover point is a point in the hierarchy where the “to” address and the “from” address share the same nodes in the hierarchy for all nodes above that point. For example, in Example A above, the crossover point is “s1”. That is, the hierarchy above s1 is the same above that point—“cnt1.s1”. In this case, the “from” address and the “to” address share the same Country and State domains. The domain below the State domain in the “to” and “from” addresses include Counties that are different, e.g., co1 and co2. Even though the identifiers after the County domain (city, house, building, and apartment) match, since they are preceded by a different County identifier, the “to” address and the “from” address are unique within each of the different Counties.

Since the “from” address contains a crossover point, the “from” address will match the “to” address at some point. Starting with the “to” address highest hierarchy position (0 array position), node 102 compares the highest hierarchy position to each domain in the “from” hierarchy starting with the highest hierarchy position, and then each position from left to right. If no matches are found, the node repeats the same procedure with the next “to” address position to the right, and this is repeated until the first match is found. The following examples are used to illustrate the above process:

### EXAMPLE A

to=“cnt1.s1.co1.c1.b1.a1”
from=“cnt1.s1.co2.c1.b1.a1”

### EXAMPLE B

to=“cnt1.s1.co1.c1.h1.b1”
from=“s1.co2.c1.h1.b1”

In example A, the highest domain, cnt1, of both the “to” address and the “from” address match and thus additional comparisons do not need to be made. In example B, the second position in the “to” address matches the first position in the “from” address, i.e., the domain s1 matches.

At 206, after finding the highest matching position in the “to” address and the “from” address arrays, node 102 finds the crossover point. The node starts from the first match in the hierarchy and then continues to compare each corresponding position in the “to” address and the “from” address array moving to the right until a position does not match. The following illustrates two examples of the above process:

### EXAMPLE A

to=“cnt1.s1.co1.c1.b1.a1”
from=“cnt1.s1.co2.c1.b1.a1”

### EXAMPLE B

to=“ cn1.s1.co1.c1.h1.b1”
from=“ s1.co2.c1.h1.b1”

In example A, the positions of cnt.s1 match, but co1 does not match co2. Therefore, the node determines the crossover point as s1. In example B, the position co1 does not match with the position co2. Therefore, the crossover point is s1. It should be noted that at the starting point for the comparison, the position in the array in the “to” address and the “from” address may be different. For example, in Example B, the position in which s1 sits in the “to” array is position 1 in the array and the position of s1 in the “from” address array is position 0. The first comparison thus starts at position 2 in the “to” address array and position 1 in the “from” address array, and so on.

At 208, node 102 calculates the U index. The U index is the distance between the crossover point and the sending domain in the “from” address. For example, node 102 calculates the U index as the number of positions in the “from” address to the end of the array (end node array position=the “from” array length −1). Then, node 102 removes the distance from the crossover point to the top of the hierarchy from this number. The following examples illustrate the U index calculation:

### EXAMPLE A

from=“cnt1.s1.co2.c1.b1.a1” (Crossover = position 1,
from_arraylength −1 = 5, u_index = 4)

### EXAMPLE B

from=“ s1.co2.c1.h1.b1” (Crossover = position 0,
from_arraylength −1 = 4, u_index = 4)

In example A, the length of the “from” array is 6. Thus, the length of the array is 6−1=5. Removing the distance from the crossover point to the top of the hierarchy is 5−1=4. The value of “1” is determined because the crossover position is position 1 in the “from” address array. In example B, the crossover is at a position 0 in the “from” address. The “from” address array length is 5−1=4. Thus, the U index is 4−0=4.

The U index is the number of nodes in which the message needs to be sent up the hierarchy until the message needs to be sent down the hierarchy. For example, referring to FIG. 1, if the crossover point is s1, which is the domain State 1, a U index of 4 would indicate that the message needs to be sent up 4 domains to the state level domain. Then, the message would need to be sent down the hierarchy to the receiving domain. This path is illustrated at 106. In this case, the message does not need to be sent through the Country 1 domain.

The following illustrates an example of software code that calculates the crossover point and U index:

```
function buildRouteIndexes(from,to){
    var from_array = from.split(“.”)
    var to_array = to.split(“.”)
    var matched = false
    var u_index = 0
    for (var to_index=0;to_index < to_array.length; to_index++){
        for(var from_index = 0; from_index<
    from_array.length;from_index++){
            matched = (to_array[to_index] ==
            from_array[from_index]);
            if(matched){
              // Is this the only match ?? //
            while (matched && to_index < to_array.length) {
              to_index++
              from_index++
              matched = (to_array[to_index] ==
              from_array[from_index]);
            }
            // While loop exits with the crossover point, now calculate
            u index//
            u_index = from_array.length − from_index
            return {u_crossover:to_index − 1,
d_crossover:from_index − 1,u_index:u_index};
        }
    }
}
```

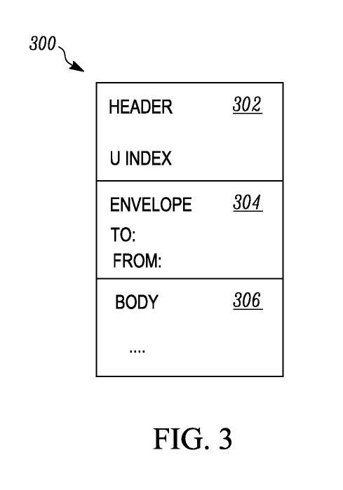

FIG. 3 depicts an example of a message 300 according to one embodiment. Although message 300 is described, other formats of message 300 will be appreciated. In one example, the U index is included in a header 302. Additionally, an envelope 304 includes the “to” address and the “from” address and a body 306 includes the content of the message. In one example, when a message is referred to, the message may include the header, envelope and body. In other examples, the message is considered the envelope and body. The header is then attached to the message. For example, the envelope and body of the message may be wrapped in a hypertext transfer protocol (HTTP) packet that includes header 302. Header 302 may then be reviewed by each node 102 in the domain hierarchy that needs to refer to the U index. Thus, each node 102 does not need to refer to body 306 to determine the U index. This allows each node 102 to determine where to route the packet without unwrapping the packet to review body 306, which may save time to route the message.

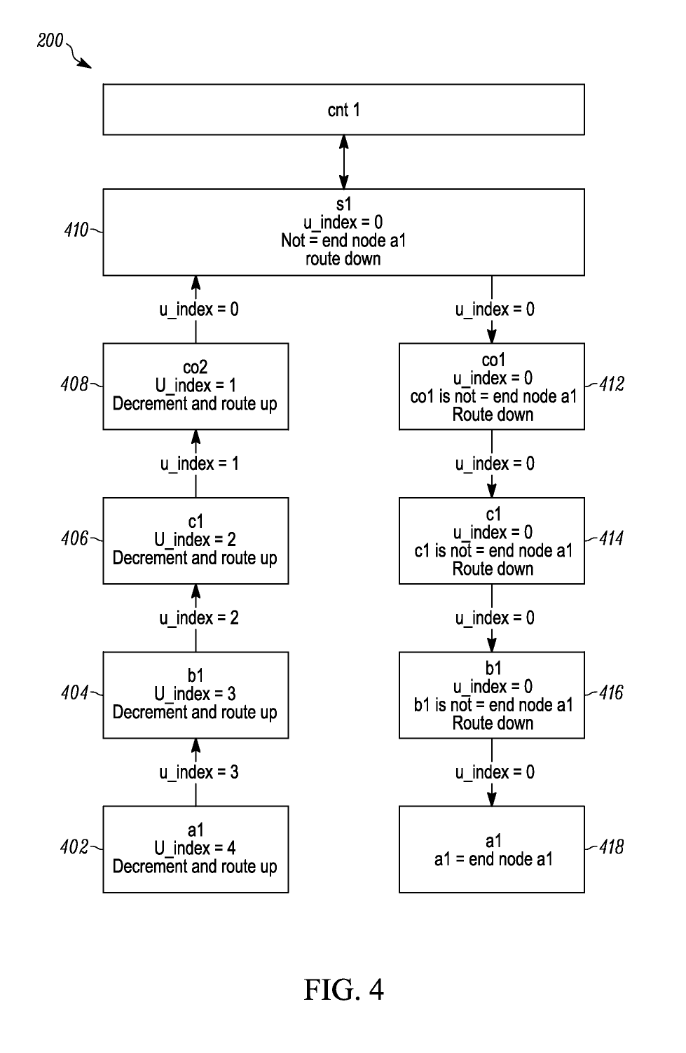

FIG. 4 depicts a simplified flowchart 400 of a method for routing messages using the U index according to one embodiment. When the index is not equal to 0, any receiving node 102 routes the message up the hierarchy. The node to which the message is routed is found in the “from” address when routing up the hierarchy. When the index is equal to 0, the node in the current domain routes the message to the next domain that is indicated in the “to” address until the node in the last domain of the “to” address is reached. In one embodiment, a node 102 may only have one parent node. Thus, the domain may always routes the message to the same parent domain when routing up the hierarchy.

The message being routed is from the “from” address and “to” address as follows:

### EXAMPLE A

to=“cnt1.s1.co1.c1.b1.a1”
from=“cnt1.s1.co2.c1.b1.a1”

At 402, a first node 102 in the Apartment 1 domain a1 determines the U index of 4, decrements the U index, and routes the message up the domain hierarchy. The message is routed up the domain hierarchy because the U index is not equal to 0. In this case, each node 102 that routes the message up the hierarchy decrements the U index. Thus, even though first node 102 in the a1 domain calculated the U index, first node 102 still decrements the index before sending the message. Also, even though first node 102 is discussed as calculating the U index, other entities may calculate the index.

At 404, a second node 102 in the Building 1 domain b1 receives the message. Second node 102 checks the U index, which equals 3, decrements the U index, and routes the message up a domain in the hierarchy. The message is routed up in the hierarchy because the U index is still not 0.

At 406, a third node 102 in the City 1 domain c1 receives the message. Third node 102 checks the U index, which equals 2, decrements the U index, and routes the message up the hierarchy. The message is routed to a domain up the hierarchy because the U index is still not 0.

At 408, a fourth node 102 in the county 2 domain co2 receives the message. The U index is 1 and thus fourth node 102 decrements the U index and routes the message up the hierarchy. Fourth node 102 routes the message up the hierarchy because the U index is still not 0.

At 410, a fifth node 102 in the State 1 domain s1 receives the message. The U index in this case is 0. Thus, fifth node 102 does not route the message up the hierarchy. In other words, fifth node 102 does not route the message to another node in the country 1 domain cnt. However, in this case, fifth node 102 needs to determine whether the message needs to be routed down in the hierarchy. In this case, fifth node 102 checks the “to” address to determine if it is in the domain that is in the last position of the “to” address—i.e., domain al. Fifth node 102 is in the s1 domain and thus, fifth node 102 routes the message down the hierarchy. Also, the U index remains at 0.

At 412, a sixth node 102 in the county 1 domain co1 receives the message. The U index is 0 and thus sixth node 102 checks to see if its domain is the same as the domain for the end node in the “to” address. The domain co1 is not the same as the domain a1 and thus the message is routed down.

At 414, a seventh node 102 in the city 1 domain c1 receives the message. Seventh node 102 checks if the domain c1 is equal to the end node of domain a1. It is not and thus the message is routed down.

At 416, an eighth node 102 in the building 1 domain b1 receives the message and determines if the domain b1 is the same as the end node domain a1. It is not and thus the message is routed down the hierarchy.

At 418, a ninth node 102 in the a1 domain receives the message. The domain a1 is the same as the end node domain and thus the message is not routed down the hierarchy any further. The routing is complete as the end node in the “to” address has received the message. In this case, the message is outputted to a user device.

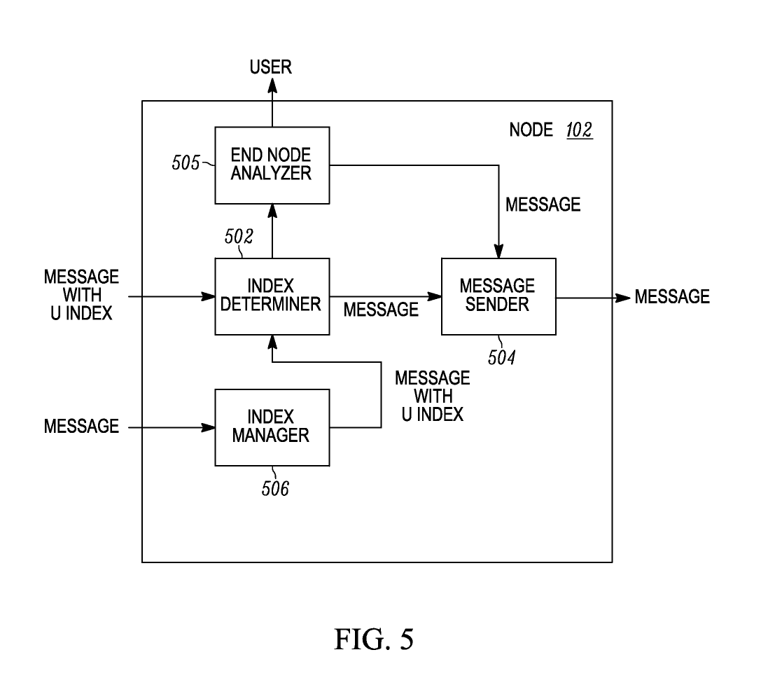

FIG. 5 depicts a more detailed example of a node 102 according to one embodiment. An index determiner 502 determines an index for a message that is received. For example, index determiner 502 determines if the index is 0. If the index is not 0, index determiner 502 decrements the index. A message sender 504 then sends the message to the next parent domain in the “from” address. If the index is 0, then an end node analyzer 505 determines if this node is the end node. For example, end node analyzer determines if this node's domain is the same as the end node domain in the “to” address. If so, the message is not routed to any other domains and may be output to a user. If not, end node analyzer 505 sends the message to message sender 504 for sending to the next child domain in the “to” address.

In an example where the message is being originated from node 102, an index manager 506 receives the message from a user device. Index manager 506 then calculates the U index from the “to” address and the “from” address. Index manager 508 then inserts the U index in header 302. Index manager 508 then sends the message up to index determiner 502, which can decrement the index as described above, and the message is sent via message sender 504.

Accordingly, an addressing scheme is provided in which multiple domains may route messages. A U index is used to determine how to route the message. Thus, nodes 102 do not need to use any look-up directories or services to determine where to route the message. Additionally, the “to” address and “from” address do not need to be altered and a receiving domain can identify the node that originally sent the message.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
determining a first address of a sender and a second address of a receiver, the first address including a first hierarchy of a plurality of domains and the second address including a second hierarchy of a plurality of domains;
calculating a crossover point based on the first hierarchy and the second hierarchy, the crossover point being one of the domains in the first hierarchy and the second hierarchy that match;
calculating an index based on the crossover point and the first hierarchy of the first address; and
sending a message from the sender to the receiver, wherein the message includes the index, wherein:
before the index reaches a predefined value, each node that receives the message adjusts the index and sends the message to a parent node based on the first address, and
when the index reaches a predefined value, each node sends the message to a child node based on the second address until a domain in which the receiver is located is reached.

2. The method of claim 1, wherein all nodes within a domain have a unique identifier.

3. The method of claim 1, wherein each node has a single defined parent node in which to send messages.

4. The method of claim 1, wherein the message includes the first address, the second address, and the index.

5. The method of claim 1, wherein the index is included in a header of a packet that includes an envelope including first address and the second address, and a body including information for the message.

6. The method of claim 1, wherein calculating the crossover point comprises:
comparing the second address to the first address to determine a highest domain within the first hierarchy and the second hierarchy that match; and
continuing the compare the second address to the first address to determine a next highest domain within the first hierarchy and the second hierarchy that do not match, wherein the crossover point is a domain before the next highest node in the first hierarchy and the second hierarchy.

7. The method of claim 1, wherein calculating the index comprises determining a distance between the crossover point and a last domain in the first hierarchy of the first address.

8. The method of claim 1, wherein the crossover point is a point in which the message should change from being routed up the first hierarchy to be being routed down the second hierarchy.

9. The method of claim 1, when the index reaches a predefined value, each node checks if it is within the domain in which the receiver is located.

10. A method comprising:
receiving, at a first node, a message from a second node, the message including a first address of a sender and a second address of a receiver, the first address including a first hierarchy of a plurality of domains and the second address including a second hierarchy of a plurality of domains;
determining an index for the message;
determining if the index equals a predefined value;
if the index does not equal the predefined value, sending the message to a parent node of the first node based on the first address; and
if the index equals the predefined value, performing
verifying the first node is not in a domain of the receiver;
if the first node is not in the domain of the receiver, sending the message to a child node of the first node based on the second address,
wherein the index is adjusted if the message is sent to the parent node of the first node based on the first address and not adjusted if the message is sent to the child node of the first node based on the second address.

11. The method of claim 10, wherein if the index equals the predefined value, the message is sent to a child node of each node that receives the message until a node in the domain of the receiver is reached.

12. The method of claim 10, wherein the crossover point is a point in which the message should change from being routed up the first hierarchy to be being routed down the second hierarchy.

13. A non-transitory computer-readable storage medium containing instructions that, when executed, control a computer system to be configured for:
determining a first address of a sender and a second address of a receiver, the first address including a first hierarchy of a plurality of domains and the second address including a second hierarchy of a plurality of domains;
calculating a crossover point based on the first hierarchy and the second hierarchy, the crossover point being one of the domains in the first hierarchy and the second hierarchy that match;
calculating an index based on the crossover point and the first hierarchy of the first address; and
sending a message from the sender to the receiver, wherein the message includes the index, wherein:
before the index reaches a predefined value, each node that receives the message adjusts the index and sends the message to a parent node based on the first address, and
when the index reaches a predefined value, each node sends the message to a child node based on the second address until a domain in which the receiver is located is reached.

14. The non-transitory computer-readable storage medium of claim 13, wherein all nodes within a domain have a unique identifier.

15. The non-transitory computer-readable storage medium of claim 13, wherein each node has a single defined parent node in which to send messages.

16. The non-transitory computer-readable storage medium of claim 13, wherein the message includes the first address, the second address, and the index.

17. The non-transitory computer-readable storage medium of claim 13, wherein the index is included in a header of a packet that includes an envelope including first address and the second address, and a body including information for the message.

18. The non-transitory computer-readable storage medium of claim 13, wherein calculating the crossover point comprises:
comparing the second address to the first address to determine a highest domain within the first hierarchy and the second hierarchy that match; and
continuing the compare the second address to the first address to determine a next highest domain within the first hierarchy and the second hierarchy that do not match, wherein the crossover point is a domain before the next highest domain in the first hierarchy and the second hierarchy.

19. The non-transitory computer-readable storage medium of claim 13, wherein calculating the index comprises determining a distance between the crossover point and a last domain in the first hierarchy of the first address.

20. The non-transitory computer-readable storage medium of claim 13, when the index reaches a predefined value, each node checks if it is within the domain in which the receiver is located.
